(19) United States
(12) Patent Application Publication
(10) Pub. No.: US 2006/0026173 A1
(43) Pub. Date: Feb. 2, 2006

(54) System and method for searching websites associated with bookmarks

(75) Inventors: Hatim Amro, Austin, TX (US); Robert G. Nadon, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/230,243

(22) Filed: Sep. 19, 2005

Related U.S. Application Data
(63) Continuation of application No. 09/668,500, filed on Sep. 22, 2000, now Pat. No. 6,950,861.

(51) Int. Cl. G06F 17/30

(52) U.S. Cl. 707/10

(57) ABSTRACT

A method that includes receiving a search term and an identifier associated with a bookmark is provided. A database is searched using the search term and a website associated with the bookmark is also searched using the search term.

### CROSS-REFERENCE TO RELATED APPLICATIONS

This application claims priority to and is a continuation of co-owned co-pending U.S. patent application Ser. No. 09/668,500, filed Sep. 22, 2000, by Hatim Amro and Robert G. Nadon, entitled SYSTEM AND METHOD FOR SEARCHING WEBSITES ASSOCIATED WITH BOOKMARKS, which is incorporated herein by reference in its entirety.

### BACKGROUND

The disclosures herein relate generally to computer systems and more particularly to searching websites associated with bookmarks using a computer system.

Web browsers such as Netscape Navigator and Microsoft Internet Explorer typically include a feature that allows a user to store a reference to a website. These references are referred to as bookmarks by Netscape Navigator and favorites by Microsoft Internet Explorer. The term bookmark will be used herein to refer to a reference to a website stored by a user. Web browsers provide a user with the ability to view the user's bookmarks and may provide a user with the ability to organize the user's bookmarks. A user, however, may store many bookmarks. The user may then be unable to easily locate a particular bookmark in the user's list of bookmarks to access a website associated with the bookmark. In addition, a user may forget which bookmark is associated with information on a website the user wishes to access.

Therefore, what is needed is a system and method for searching a website associated with a bookmark.

### SUMMARY

One embodiment, accordingly, provides a method that includes receiving a search term and an identifier associated with a bookmark. A database is searched using the search term and a website associated with the bookmark is also searched using the search term.

A principal advantage of this embodiment is that it allows a user to locate previously stored information. A user may more quickly identify information for which the user is searching and may access that information in an efficient manner. The embodiment may also allow the user to more effectively use features of a web browser.

### BRIEF DESCRIPTION OF THE DRAWINGS

FIG. 1 is a diagram illustrating an embodiment of computer systems coupled to a communications network.

FIG. 2 is a diagram illustrating an embodiment of a user interface of a web browser configured to allow a user to access a search engine.

FIG. 3 is a diagram illustrating an embodiment of a user interface of a web browser configured to display results from a search engine.

FIG. 4a is a flowchart illustrating an embodiment of a method for searching websites associated with bookmarks.

FIG. 4b is a flowchart illustrating an embodiment of a method for searching websites associated with bookmarks.

### DETAILED DESCRIPTION

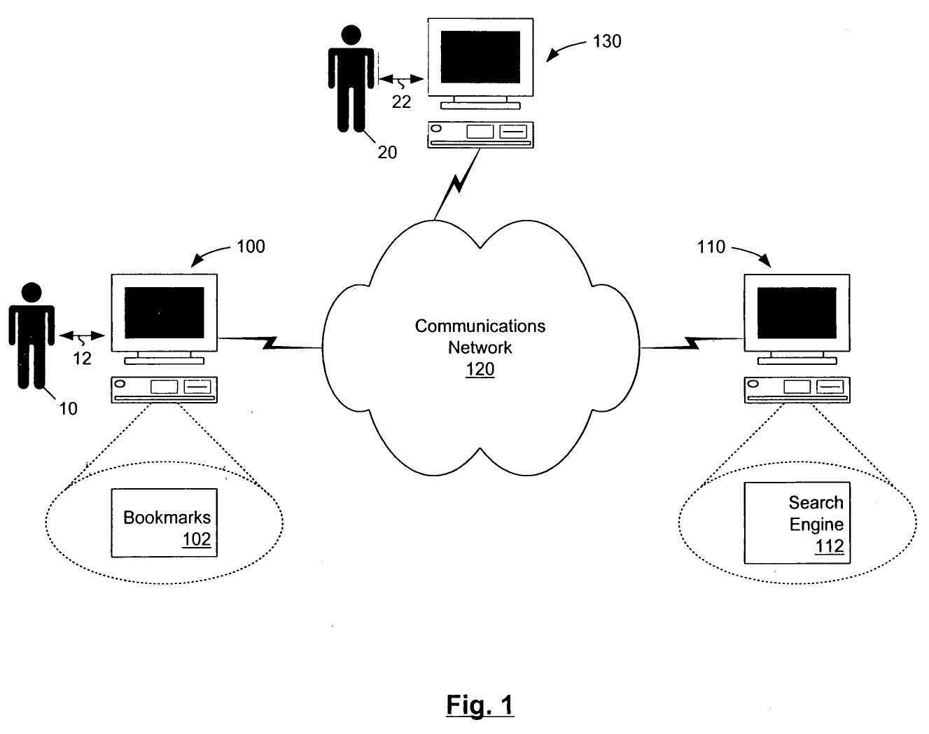

FIG. 1 is a diagram illustrating an embodiment of computer systems coupled to a communications network 120. In FIG. 1, a computer system 100, a computer system 110, and a computer system 130 are coupled to communications network 120. Computer system 100 includes bookmarks 102, and computer system 110 includes search engine 112.

Search engine 112 may be any search engine accessible using communications network 120 such as Lycos (http://www.lycos.com), AltaVista (http://www.altavista.com), HotBot (http://www.hotbot.com), Webcrawler (http://www.webcrawler.com), or a private search engine available only to certain users.

Computer systems 100, 110, and 130 may be any type of computing device configured to process, receive, and transmit information. Computer system 100 receives inputs from and provides outputs to a user 10 as indicated by arrows 12. Similarly, computer system 130 receives inputs from and provides outputs to a user 20 as indicated by arrows 22.

Communications network 120 may be any type of wired or wireless network configured to receive and transmit information such as the Internet, an intranet, a local area network (LAN), or a wide area network (WAN).

Web browsers such as Netscape Navigator and Microsoft Internet Explorer typically include a feature that allow a user to store a reference to a website. These references are referred to as bookmarks by Netscape Navigator and favorites by Microsoft Internet Explorer. The term bookmark will be used herein to refer to a reference to a website stored by a user.

As shown in FIG. 1, user 10, using a web browser, causes bookmarks 102 to be stored on computer system 100. Bookmarks 102 may be stored in a bookmark file. To search websites associated with bookmarks 102, user 10 provides a search term to search engine 112 on computer 110 using communications network 120. An identifier for each bookmark in bookmarks 102 is also provided to search engine 112. A script written in the Java programming language may be used to generate the identifiers. In one embodiment, an identifier includes a URL (Uniform Resource Locator) or a website address associated with a bookmark. In other embodiments, identifiers may include other information. User 10 may select an indicator to cause search engine 112 to search websites associated with bookmarks 102. Alternatively, a search engine may automatically cause websites associated with bookmarks 102 to be searched.

A user may also cause websites associated with bookmarks on a remote computer system to be searched. In FIG. 1, user 20 inputs a search term into computer system 130 and specifies that websites associated with bookmarks 102 on computer system 100 are to be searched. Search engine 112 receives the search term and accesses bookmarks 102 to obtain identifiers for the websites associated with bookmarks 102. Search engine 112 performs a search of a database and the websites associated with bookmarks 102 using the search term and provides the search results to computer system 130. Computer system 130 displays the search results to user 20.

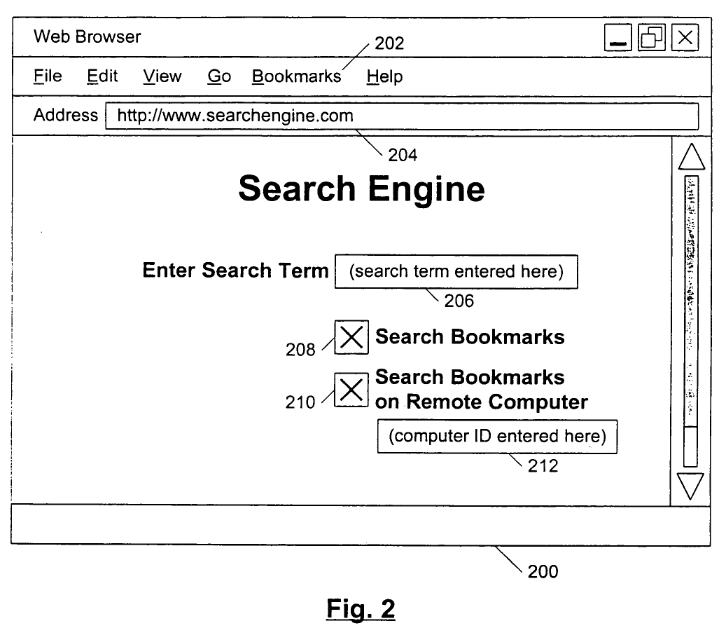

FIG. 2 is a diagram illustrating an embodiment of a user interface 200 of a web browser configured to allow a user to access a search engine. FIG. 2 shows an example search engine website using a web browser. The web browser may be run on computer system 100 or computer system 130 shown in FIG. 1. The example search engine website is accessed using a URL, http://www.searchengine.com, entered into box 204, or alternatively, access using “Bookmarks” menu 202, to cause the search engine website to be displayed as shown.

A user inputs a search term into box 206 to cause the search engine to perform a search using the search term. The user also selects checkbox 208, as indicated by the X in checkbox 208, to cause websites associated with the user's bookmarks to be searched. The user may also select checkbox 210, as indicated by the X in checkbox 210, to cause websites associated with bookmarks stored on a remote computer system to be searched. The user inputs an identifier of the remote computer system in box 212. This identifier may be a URL or another type of information that designates bookmarks stored on a particular computer. The bookmarks on the remote computer system may be the user's own bookmarks or another user's bookmarks.

Referring back to FIG. 1, search engine 112, executing on computer system 110, receives a search term and one or more identifiers associated with bookmarks 102 from computer system 100. Search engine 112 searches a database using the search term. The database may be a part of search engine 112 or may be located on a remote computer system (not shown). Search engine 112 also searches websites associated with bookmarks 102. Search engine 112 then provides the results of searching the database and the websites to computer system 100.

Search engine 112 may also receive a search term and an identifier that identifies computer system 110 from computer system 130. In this case, search engine 112 causes bookmarks 102 on computer system 100 to be accessed and receives identifiers associated with bookmarks 102. Search engine 112 searches the database and websites associated with bookmarks 102 and provides the results of the searches to computer system 130.

In response to receiving results from search engine 112, computer system 110 displays the results to user 10. User 10 selects a result to cause a website associated with the one of bookmarks 102 to be displayed. Search engine 112 may also provide an advertisement to be displayed on computer system 110. Search engine 112 may use the search term and/or information from the identifiers associated with bookmarks 102 to select the advertisement to be provided to user 10. In this way, an advertisement can be targeted for user 10 based on a preference of user 10 deduced from the search term and/or information from bookmarks 102. Computer system 130 operates similarly in response to receiving results from search engine 112.

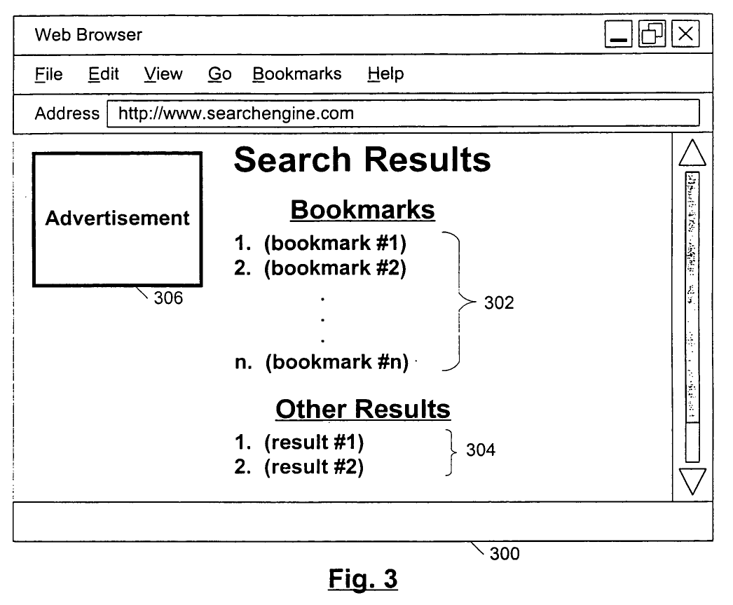

FIG. 3 is a diagram illustrating an embodiment of a user interface 300 of a web browser configured to display results from a search engine. Results are displayed in user interface 300 as shown. The results include bookmark results 302 and other results 304. Bookmark results 302 and other results 304 are displayed on separate sections of the webpage as shown. In other embodiments, bookmark results 302 may be specially highlighted or displayed in a separate window to draw a user's attention. A user may select one of bookmark results 302 and one of other results 304 to cause a webpage associated with the selected result to be displayed.

An advertisement 306 may also be displayed in the results webpage. Advertisement 306 may be selected by the search engine based on the search term and/or information from bookmarks used in the search.

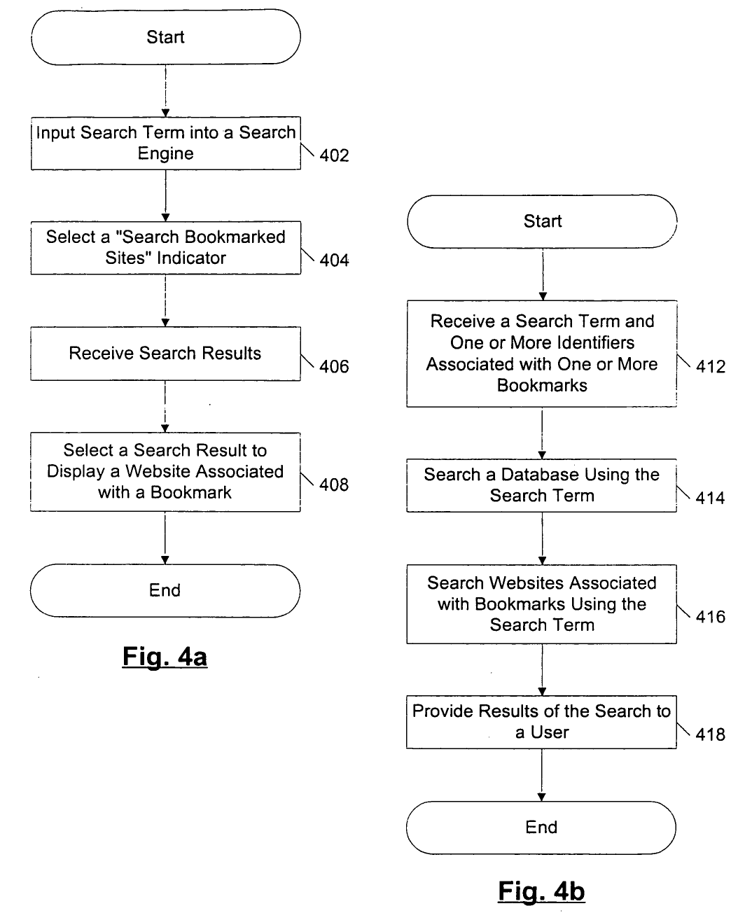

FIG. 4a is a flowchart illustrating an embodiment of a method for searching websites associated with bookmarks from the perspective of a user. A search term is input into a search engine as indicated in step 402. A “Search Bookmarked Sites” indicator is selected as indicated in step 404. Where a search engine is set to search websites associated with bookmarks by default, this step may be omitted. Search results are received as indicated in step 406. The search results may be presented to the user in any suitable manner such as displaying them on a user device. The search results associated with bookmarked websites may be highlighted or displayed separately from other search results. A search result is selected to display a website associated with the bookmark as indicated in step 408.

FIG. 4b is a flowchart illustrating an embodiment of a method for searching websites associated with bookmarks from the perspective of a search engine. A search term and one or more identifiers associated with one or more bookmarks are received as indicated in step 412. One identifier may be received for each of a user's bookmarks. In one specific embodiment, an identifier is an address of a website. A database is searched using the search term as indicated in step 414. It may be noted that the database may be directly associated with the search engine or may be accessed remotely. Websites associated with the bookmarks are searched using the search term as indicated in step 416. Results of the search are provided to a user as indicated in step 418.

As can be seen, the principal advantages of these embodiments are that they allow a user to locate previously stored information. A user may more quickly identify information for which the user is searching and may access that information in an efficient manner. The embodiments may also allow the user to more effectively use features of a web browser. The embodiments may supplement the organizational aspects of bookmarks by allowing a user to search websites associated with the bookmarks.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method comprising providing a user interface on a web browser to allow a user to access a search engine, the user interface allowing a user to:
input a search term;
input an identifier of a remote computer system; and
make a selection to cause the search engine to perform a search, using the search term, of websites associated with at least one bookmark stored on the remote computer system.

2. The method of claim 1, the user interface also allowing the user to make a selection to cause the search engine to perform a search, using the search term, of websites associated with at least one bookmark stored on a computer executing the web browser.

3. The method of claim 2, the method further comprising displaying, on the web browser, results of the search of websites associated with the bookmarks stored on the remote computer system and on the computer executing the web browser.

4. The method of claim 1, the method further comprising displaying, on the web browser, results of the search of websites associated with the at least one bookmark stored on the remote computer system.

5. The method of claim 4, the method further comprising displaying, along with the results of the search, an advertisement related to the search term.

6. The method of claim 4, the method further comprising displaying, on the web browser, results of a general search performed using the search term.

7. The method of claim 6, further comprising highlighting the results of the search of websites associated with the at least one bookmark stored on the remote computer system.

8. The method of claim 1, the method further comprising automatically searching, using the search term, websites associated with bookmarks stored on a computer executing the web browser.

9. A method of performing a search, the method comprising:
providing a web browser user interface to a user on a first computer, the user interface allowing a user to input a search term, input an identifier of a remote computer system, and make a selection to request a search, using the search term, of websites associated with at least one bookmark stored on the remote computer system;
receiving information related to the user interface user input;
retrieving the at least one bookmark stored on the remote computer system;
initiating a search of websites associated with the at least one bookmark, using the search term; and
providing results of the search to the user.

10. The method of claim 9, the method further comprising:
retrieving at least one bookmark stored on the first computer;
initiating a search of websites associated with the at least one bookmark stored on the first computer, using the search term; and
providing, to the user, the results of the search of websites associated with the at least one bookmark stored on the first computer.

11. The method of claim 10, wherein the user interface allows a user to make a selection to request the search of websites associated with the at least one bookmark stored on the first computer.

12. The method of claim 10, wherein the retrieval of at least one bookmark stored on the first computer and corresponding search are performed automatically when a search is requested.

13. The method of claim 9, the method further comprising:
initiating a general search using the search term; and
providing results of the general search to the user, identified separately from the results of the search of websites associated with the at least one bookmark.

14. The method of claim 9, the method further comprising:
identifying an advertisement related to the search term; and
displaying the advertisement to the user along with the results of the search.

15. An article of manufacture comprising a computer-readable medium containing instructions that, when executed by one or more processors, cause the one or more processors to perform a method comprising:
providing a web page user interface to a user on a first computer, the user interface allowing a user to input a search term, input an identifier of a remote computer system, and make a selection to request a search, using the search term, of websites associated with at least one bookmark stored on the remote computer system;
receiving information related to the user interface user input;
retrieving the at least one bookmark stored on the remote computer system;
initiating a search of websites associated with the at least one bookmark, using the search term; and
providing results of the search to the user as a results web page.

16. The article of manufacture of claim 15, wherein the method further comprises:
retrieving at least one bookmark stored on the first computer;
initiating a search of websites associated with the at least one bookmark stored on the first computer, using the search term; and
providing, to the user as part of the results web page, the results of the search of websites associated with the at least one bookmark stored on the first computer.
